(19) United States
(12) Patent Application Publication
(10) Pub. No.: US 2011/0018420 A1
(43) Pub. Date: Jan. 27, 2011

(54) METHOD FOR CONFIGURING A LENGTH OF AN ELECTRODE OF A DISCHARGE LAMP AND DISCHARGE LAMP

(75) Inventors: Ulrich Hartwig, Berlin (DE); Matthias Morkel, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/933,095

(22) PCT Filed: Mar. 19, 2008
(86) PCT No.: PCT/EP08/53265

§ 371 Date: Sep. 17, 2010

(51) Int. Cl. H01K 1/26; H01J 9/02; H01J 61/02; H01K 1/50

(52) U.S. Cl. 313/113; 445/46; 313/567; 313/579

(57) ABSTRACT

A method for designing a length of an electrode of a discharge lamp may include introducing fill materials into a discharge space of a lamp bulb of the discharge lamp; combining at least a first fill material with evaporated electrode material during operation of the discharge lamp; and forming a storage material for the electrode material in the lamp bulb by the combination, the electrode material contained in the storage material being released again as a function of a temperature effect on the storage material and being transported to the tip of the electrode and being deposited there so as to lengthen the electrode.

### TECHNICAL FIELD

The invention relates to a method for designing a length of an electrode of a discharge lamp, and to a discharge lamp.

### PRIOR ART

In the course of the service life of a high-pressure gas discharge lamp, the electrodes slowly burn back. As a result, the starting voltage, the operating voltage and the luminance are reduced. If the starting voltage of the lamp exceeds the starting voltage of the operating equipment of the lamp, the lamp can no longer ignite. When the operating voltage exceeds the electric voltage that is provided by the operating equipment, the lamp is extinguished during operation. The reduced luminance leads to an increased light conductance (etendue) of the light source, and thus to a lesser quantity of light that can be used by a given optical system. The duration of the usefulness of the lamp for a specific application is hereby reduced.

### SUMMARY OF THE INVENTION

It is an object of the present invention to provide a method and a discharge lamp in the case of which an undesired extinction of a discharge lamp because of such an electrode burnback can be prevented, and the service life can be lengthened.

This object is achieved by a method that has the features as claimed in claim 1, and a discharge lamp that has the features as claimed in claim 18.

In the case of an inventive method for designing a length of an electrode of a discharge lamp, fill materials are introduced into a discharge space of a lamp bulb of the discharge lamp. During operation of the discharge lamp, at least a first fill material is combined with electrode material evaporating during operation, and a storage material for the electrode material is formed in the lamp bulb by the combination between the evaporated electrode material and the first fill material. The electrode material contained in the storage material is then released again as a function of a temperature effect on the storage material produced and is transported to the tip of the electrode where it is deposited while the discharge lamp is operating so as to lengthen the electrode. The method thus provides the possibility that as the discharge lamp is operating the length of the electrode can therefore be adjusted as a function of requirements, and it is therefore possible to prevent an undesired excessive electrode burnback. During operation of the lamp, an electrode can therefore be individually re-enlarged reversibly in an independent fashion such that excessive spacing between two electrodes of a discharge lamp can be prevented. It is also thereby possible to prevent the lamp being extinguished during operation because of an excessive electrode burnback and an excessive spacing, resulting therefrom, between the two electrodes.

The variation in length of the electrode is preferably carried out under automatic control during operation of the discharge lamp. Owing to this mode of procedure, it is therefore possible to provide a self-regulating system that independently detects an excessive electrode burnback and, in particular, automatically starts and carries out the lengthening of the electrode that is required in turn.

It proves to be particularly preferred to release the electrode material contained in the storage material formed as a function of requirements during operation of the discharge lamp. In this case, control as a function of requirements can be started by a lamp user, and thus a person. However, it is also possible to provide that such monitoring and autonomous execution be carried out by an automatic control depending on detection of a required lengthening of the electrode. In particular, the electric voltage can be used as a parameter in this context. For example, this voltage rises as the distance between electrodes increases, and thus in the case of undesired electrode burnback, it then being possible, given that the actual voltage exceeds a prescribable or predefinable voltage threshold, to detect that the electrode burnback has reached a critical range that is disadvantageous for the operation of the discharge lamp, as a result of which it is then possible under automatic control to produce the storage material and/or, in particular, to release the electrode material stored in the storage material, and then also to automatically transport this released electrode material to the tip of the electrode, and then subsequently to apply this electrode material at the tip. The required growth in length of electrode as the discharge lamp is operated can preferably be dosed such that both the duration of the increase and the amount of storage material released can be adjusted individually. Both the temporal duration of a lengthening of the electrode and/or the addition of the released electrode material from the storage material can thereby be varied specifically depending on the situation.

At least an inert gas and a metal halide and/or mercury are/is introduced as fill materials, and an additional halogen or halide is introduced as first fill material.

It proves to be preferred when bromide or iodine is additionally introduced into the discharge space as halogen.

It proves to be particularly preferred when the storage material has a dissociation temperature that is tuned to the temperature of the electrode tip during operation of the discharge lamp. It can be ensured by such a specification of the halogen that the corresponding combination of the halogen with the electrode material is not dissociated at an excessively low temperature, thus releasing the stored electrode material in an undesired fashion. In particular, it can be achieved particularly advantageously by such a temperature tuning that the released electrode material is then also particularly preferably transported to the electrode tip in order to be deposited there so as to lengthen the electrode.

The first fill material is preferably introduced in a concentration that is higher by at least 100% than during operation without additional automatic variation in length of the electrode. It proves to be particularly preferable when a substantial amount of additional halogen is fed to the lamp in this context. The halogen combines with the evaporating electrode material, in particular tungsten and oxygen, during operation of the lamp. The tungsten halides and tungsten oxyhalides decompose at particularly hot spots inside the discharge vessel such that tungsten is finally transported back to the electrode and is not deposited on the wall of the discharge vessels. By this process it is advantageously possible to achieve that no blackening of the discharge vessel occurs.

By way of example tungsten halides can be WBr₄ or WI₄. Tungsten oxyhalides can, for example, be WO₂Br₂ or WO₂I₂.

An additional advantageous effect results from a dosing of the halogen that is yet higher by comparison therewith.

Crystallites are then caused to grow in the surroundings of the tip of the electrode and gradually melt on. This causes transport of the electrode material, in particular tungsten, to the electrode tip such that the spacing between the two electrodes is reduced. The electrode burnback can thereby be compensated in a self-regulating fashion.

In order also to be able further to control the described effect particularly advantageously in a fashion that is individual and dependent on the situation, it is advantageous when the lamp bulb or the discharge vessel is designed with cold traps.

If the temperature at these “cold” spots is low enough, a certain amount of the storage material, in particular tungsten halides and tungsten oxyhalides, condenses here and is therefore withdrawn from the cyclic process. The transport of electrode material, in particular tungsten, to the tip of the electrodes is therefore slowed down and compensated or over-compensated by the burnback of the electrodes.

If the aim is to reduce the electrode spacing, the temperature can then be increased depending on the situation at local spots at which storage material is condensed out and stored, such that said storage material is re-evaporated. Consequently, the electrode material stored in the storage material is released again and transported to the electrode tip. The additional first fill material, in particular a halogen or a halide, in the atmosphere of the discharge vessel then ensures the desired transport of material to the tip of the electrodes.

It proves to be preferred when the fill materials are combined such that under the given conditions of temperature and pressure in the lamp bulb, and thus also in the discharge space, no components of the fill materials other than the first fill material condense out with the electrode material in the form of the storage material. An inert gas fill is particularly advantageous in this context.

It proves to be preferred when cooling of the lamp bulb is carried out locally in order to produce the storage material under control, in order thereby to be able to ensure that the storage material condenses out in a way that is targeted and locally specific.

It is preferably provided in this context that the cooling is adjusted automatically in dependence on the production, as a function of requirements, of storage material and/or in dependence on the extension of an electrode as a function of requirements. It is also possible thereby to adjust and vary the cooling individually both in terms of time and with regard to its intensity. The amounts of storage material that can thereby be achieved and their local deposition and therefore also their evaporation as a function of requirements for releasing the stored electrode material can thereby be implemented very precisely and exactly.

As a result of the local cooling of the lamp bulb, storage material is preferably condensed out and deposited in a locally specific fashion in the lamp bulb as solid state material. In particular, the cooling is carried out locally such that the deposition of the storage material condensed out is prescribed in the lamp bulb with local accuracy.

In particular, the deposition of the storage material condensed out is carried out in a shadow region of the electrode. In this context, the term “shadow region of an electrode” denotes those regions that do not have a disturbing effect on the light emissions of the lamp to the extent that disturbance from light scattering and light absorption occurs on the storage material condensed out.

The electrode spacing is therefore preferably controlled by a controllable cold trap. The additional first fill material added to the discharge space, in particular a halogen or a halide, should therefore preferably be selected such that it decomposes as tungsten halide or tungsten oxyhalide only in the vicinity of the particularly hot electrode tips. The discharge vessel is preferably cooled in a region on which the halides can be deposited.

In particular, it can be provided that cooling is carried out by an air flow and/or a liquid flow incident on the lamp bulb from outside. It is possible thereby to enable a simple local cooling that can be provided and operated at low outlay. Moreover, an adequate effectiveness of the cooling and a corresponding local precision for the cooling points are also thereby possible.

The lamp bulb or the discharge vessel can also have an integrated cold trap, as it were, as far as its basic design is concerned. The cold trap can then, for example, be actively heated, or a device for heat accumulation can be fitted. In particular, in the case of such a heat accumulation device it is possible in turn to enable self-regulating heating. By way of example, it is possible in this context to provide as heat accumulation device a thermal bulb which at least partially slips over a storage region in which the storage material condensed out is contained, or at least partially surrounds said storage region. In said storage reason, which is preferably arranged as an extension on the discharge vessel, and is particularly arranged there on a bellied central part of the discharge vessel, said heat accumulation device can then be slipped over. The heat accumulation device can be coated on its inside and/or its outside and, in particular, coated with a material that reflects thermal radiation. In particular, it is possible thereby to provide by way of example a metallization such that the heat accumulation device serves, as it were, as a heat store. It is thereby possible as a result for the storage region, designed as an extension in particular, to be heated as a function of requirements, and thereby also to enable the heating of the storage material stored therein in a fashion that is precise and is a function of requirements.

The lamp bulb is preferably heated locally to above the evaporation temperature of the storage material in order to release the electrode material from the storage material. The storage material is thereby evaporated and can contribute to the material transport of the electrode material, preferably up to the tip of the electrodes, since during operation of the discharge lamp, a temperature prevails there that is substantially higher or at least similar to the dissociation temperature during operation of the lamp.

The storage material is preferably condensed out in a tubular extension that is arranged on the bellied central part of the lamp bulb and designed as a cold trap. In particular, this extension is then heated from outside in order to release the electrode material from the storage material. It is possible in this context for a simple heating device to have been provided or, for example, to use the heat accumulation device already mentioned above.

However, it can also be provided that the temperature of the cold trap is controlled by the position of the lamp bulb. In this context, it is possible to provide as initial position one in which the extension is firstly directed downward. By rotating the lamp bulb to the effect that the extension is oriented upward and located at a higher level by comparison with the initial position, it is also possible here to utilize the physical effect of the heating, since it is warmer at the upper position than at the lower position.

The electrode burnback can be compensated and, in particular, individually compensated as a function of situation and requirements, by means of the inventive method. In particular, it is possible thereby to produce a desired length after a burnback. The lamp voltage is thereby reduced and the focusability of the light source improved. The service life of the lamp can thereby be lengthened.

An inventive discharge lamp includes a lamp bulb that has a bellied central part in which a discharge lamp is constructed. At least one elongated electrode, in particular two electrodes, extend into the discharge space, fill materials being introduced into the discharge space. The fill materials have at least a first fill material that can be chemically combined with evaporated electrode material during operation of the discharge lamp, and a storage material for the electrode material can be produced in the lamp bulb by the combination. The electrode material contained in the storage material can be released again as a function of a temperature effect on the storage material, and the released electrode material can be transported to the tip of the electrode so as to lengthen and be deposited on the electrode. It is thereby possible to prevent an undesired electrode burnback and an undesired impairment of the discharge lamp during operation that is associated therewith. Not least, the service life of the lamp can thereby also be lengthened.

The discharge lamp preferably includes a cold trap for condensing out storage material from the gaseous material in the discharge space, during operation of the discharge lamp. The cold trap preferably has a cooling fan that produces an air flow incident locally on the lamp bulb from outside. It can also be provided that the cold trap has a device that cools the lamp bulb with liquid medium from outside. It can likewise be provided that the cold trap has an extension that is, in particular, tubular and is arranged on the central part of the discharge vessel and into which the storage material can be condensed out, depending on the situation, because of the lower temperature by comparison with the neighboring discharge space. The storage material condensed out can be heated specifically in order to re-release the electrode material contained therein as a function of requirements.

In particular, the first fill material is a halogen or a halide. In this context, it is particularly advantageous when the amount of first fill material, in particular a halogen or a halide, is larger, in particular substantially larger, in particular larger by at least 100%, than the amount of first fill material that is introduced during operation without an additional automatic variation in length of the electrode. It is precisely owing to such a large increase in this amount of this specific first fill material that it is possible for the effect of the formation of storage material and the subsequent release by heating the storage material to be used particularly effectively and with regard to the electrode lengthening.

In particular, the storage material has a dissociation temperature that is near to or lower than the temperature of an electrode tip during operation of the discharge lamp. As a result of this specification, it is possible with particular advantage for the fill material, after having been released from the storage material, to be transported, with particular preference automatically, in the direction of the electrode tip in order to be able to be deposited there.

The course of controllable electrode growth is explained once again below in context. Evaporation of electrode material comes about during operation of the lamp. The first fill material combines with the electrode material and becomes storage material. The storage material now has two possibilities:

Firstly, it comes into the vicinity of the hot electrode tips and decomposes there to form the electrode material, which is deposited on the tips, and the first fill material. This effects transport of material to the tips of the electrodes.

Furthermore, the storage material can find a place in the discharge vessel that is cold enough for it to condense out there. The storage material is therefore solid. The bound first fill material is withdrawn from the atmosphere of the discharge vessel and cannot participate in the material transport.

The amount that is condensed out can be controlled via controllable cold traps. It is therefore also possible to control the material transport.

Halogens (Br, I) or halides (=halogen compounds) WBr₄, WO₂Br₂, HBr, . . . can be used as first fill material.

It is also possible for the first fill material to decompose during operation of the lamp (for example HBr, or other halides) and for only one component, for example the halogen Br, to combine with the electrode material to form the storage material. In this case, the first fill material (HBr) possibly does not return to this compound again (H can diffuse out of the discharge vessel through the glass).

The first fill material can, but need not, be gaseous at room temperature (WBr₄).

It is particularly advantageous to keep the electrode spacing as constant as possible in the case of reflector lamps. The reason for this is that the focusability of the light worsens when the arc length increases. The possibility of bringing the electrode spacing during operation, for example after several hundred hours of burning time, up to the initial value again means that this lamp then brings more light again to the application.

Moreover, a control circuit can be used to adjust the exact electrode spacing in a defined fashion. A short-term increase in the current or an omission of commutation in the case of the lamps which are operated by AC causes the electrode spacing to grow. The control of the cold trap can now cause the electrodes to grow together again a little.

Further advantageous designs follow from the subclaims.

### BRIEF DESCRIPTION OF THE DRAWINGS

Exemplary embodiments of the invention are explained in more detail below with the aid of schematic drawings, in which:

FIG. 1 shows a first exemplary embodiment of an inventive discharge lamp;

FIG. 2 shows a second exemplary embodiment of an inventive discharge lamp;

FIG. 3 shows a third exemplary embodiment of an inventive discharge lamp;

FIG. 4 shows a fourth exemplary embodiment of an inventive discharge lamp;

FIG. 5 shows a fifth exemplary embodiment of an inventive discharge lamp; and

FIGS. 6a, 6b respectively show an illustration of two different positions of an inventive discharge lamp with regard to cold trap control.

### PREFERRED DESIGN OF THE INVENTION

Identical or functionally identical elements are provided in the figures with identical reference numerals.

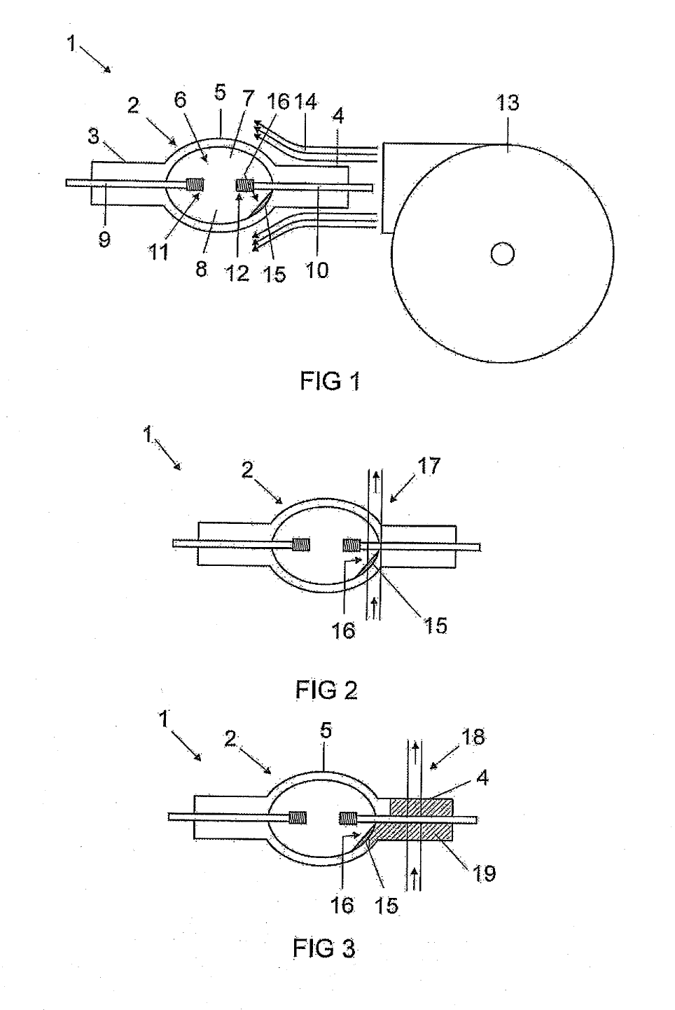

FIG. 1 shows in a schematic illustration a discharge lamp 1 that has a discharge vessel in the form of a lamp bulb 2. The lamp bulb 2 has two bulb necks 3 and 4 that extend diametrically from a bellied central part 5 of the discharge vessel 2. A discharge space 6 is formed in the interior of the bellied central part 5. Fill materials 7 are introduced in the discharge space 6. By way of example, these can include inert gases, metal halides and/or mercury. Moreover, the fill materials 7 include a first fill material 8 that, in the exemplary embodiment, is an additional halogen or a halide.

In the exemplary embodiment, the discharge lamp 1 is designed as a xenon short arc high pressure discharge lamp (XBO). However, it can also be designed as some other type of discharge lamp. In the exemplary embodiment, use is made as first fill material 8 of the halogen bromine, which can be introduced in the form of HBr into the discharge space 6 with a concentration of, for example, 4000 ppm. It may be pointed out in this context that other halogens can also be introduced as first fill material 8, and that it is also possible, furthermore, to provide different concentrations.

In addition, the discharge lamp 1 includes two rod-shaped electrodes 9 and 10 which respectively extend into the discharge space 6 via the bulb necks 3 and 4. The electrodes 9 and 10 are arranged with their tips 11 and 12 facing one another, but at a spacing from one another.

In the exemplary embodiment, the two electrodes 9 and 10 are constructed from high purity tungsten as electrode material.

Moreover, the discharge lamp 1 includes a cold trap that is designed in FIG. 1 as a separate cooling fan 13. The cooling fan 13 can be used to produce a cooling air flow 14 that can be incident on the discharge vessel 2 from outside at particular places in a local and specific fashion.

In order to design a specific length of an electrode 9 or 10, a storage material 15 that is composed of the first fill material 8 and the evaporated electrode material, specifically tungsten, combined therewith, is produced during operation of the discharge lamp 1. The halogen bromine combines with the evaporating tungsten and oxygen during operation of the lamp. The tungsten halides or tungsten oxyhalides resulting therefrom are then cooled by the cold trap 13 and by the cooling air flow 14 and are thereby condensed out. In the exemplary embodiment, the entirely specific local incidence of the cooling air flow 14 ensures that the storage material 15 condenses out and is deposited as solid state material in a shadow region 16 of the electrode 10. The shadow region 16 is thereby defined in the exemplary embodiment in a region that is situated virtually behind the electrode 10, and is formed as close as possible to the region of the inner wall of the central part 5 in the region where the electrode 12 enters the bulb neck 4. Consequently, the light emission of the entire discharge lamp 1 is not impaired by the storage materials 15 stored there in a locally specific fashion, since the scattering or absorption of light by these storage materials 15 has no disturbing effect.

In the design shown, the first fill material 8 is of a higher, in particular substantially higher, dose than would be the case when the operation of the discharge lamp 1 is provided without the length of the electrode being adjusted in such an independently regulating and controlling fashion.

This higher dosing of the halogen results in the additional effect of the growth of crystallites in the surroundings of the tips 11 and 12 of the electrodes 9 and 10 being brought about, said tips gradually melting on. Tungsten is thus transported to the electrode tips 9 and 10 such that the electrode spacing is reduced.

In order in this context to be able to prevent the electrode being lengthened in an undesired way, electrode length can be adjusted under control by the configuration of the cold traps, in the exemplary embodiment in accordance with FIG. 1 by the specific local incidence of the cooling air flow 14 on the lamp bulb 2. Thus, once an appropriate cooling is achieved at these special places, in the exemplary embodiment in the shadow region 16, the storage material, in particular the tungsten halides or tungsten oxyhalides, can then be condensed out at these then sufficiently cold places, and this storage material is therefore withdrawn from the cyclic process. The transport of tungsten to the tips 11 and 12 of the electrodes 9 and 10 is thereby slowed down and temporarily deliberately compensated or overcompensated by the burnback of the electrodes 9 and 10.

If the aim then is to reduce the electrode spacing and not proceed further with the electrode burnback, the temperature is increased at the places where the tungsten halides or tungsten oxyhalides 15 are condensed out, such that this storage material 15 evaporates in the shadow region 16. The storage material decomposes at the tips 11, 12 of the electrodes 9, 10 into its components, specifically tungsten, a halogen and, if appropriate, oxygen. The tungsten is deposited on the electrode 9, 10. There is thus a transport of tungsten material in the direction of the electrode tips 11, 12.

This is particularly promoted whenever no other components of the fill materials condense out under the given conditions of temperature and pressure in the lamp. An inert gas fill is particularly advantageous in this context. Moreover, it is particularly advantageous when the first fill material, specifically the halogen, is tuned to the temperatures in the discharge lamp such that the tungsten is preferably transported to the electrode tips 11 and 12. It is particularly advantageous in this context when the dissociation temperature of the storage material 15 consisting of the halide that forms from the halogen of the first fill material 8 and the material of the electrodes 9 and 10, is tuned to the temperature of the electrode tips 11 and 12 during operation of the discharge lamp, and these are at least very similar. This is because it is precisely then that it is possible for the released electrode materials to be transported automatically and preferably from the storage material 15 to the tips 11 and 12 in a targeted fashion, and for the deposition thereon to be promoted.

It is therefore possible to adjust the variation in the length of the electrode as a function of the situation and requirements under automatic control. In this context, the fan 13 can be activated and deactivated by a user for the purpose of producing the cooling air flow 14 during operation of the discharge lamp. It is preferably provided in this context that this is performed automatically by an electronic control. In this context, this control of the fan 13 can be performed as a function of one or more physical operating parameters. It proves to be particularly preferred in this context that the electric voltage between the electrodes 9 and 10 is used as such a design parameter. It can be determined very accurately with the aid of the latter whether a desired or undesired range of the electrode spacing is reached or left. The cooling to requirements, on the one hand, and/or the desired heating of the storage material 15, on the other hand, can then be performed in this context.

A further exemplary embodiment is shown in FIG. 2 in a schematic illustration. In the case of this design, a cold trap 17 is implemented that leads to cooling of a gaseous or liquid medium that flows round the lamp bulb 2 in a locally specific fashion. Here, as well, the locally positioned cooling is applied such that the storage material in the shadow region 16 condenses out. In this context, the cold trap 17 can have a hose or a tube through which the liquid flow or else a gas flow can be guided.

FIG. 3 shows a further exemplary embodiment in a schematic illustration. A cold trap 18 is implemented in this context, heat being guided away from a thermally conducting layer of the lamp bulb or discharge vessel 2 and being cooled further back by a gas or liquid flow. The thermally conducting layer 19 is applied in this context to the bulb neck 4. As may be seen, it extends on one side of the lamp bulb 2 as far as into the bellied central part 5 such that here, too, the storage material 15 in the shadow region 16 condenses out again.

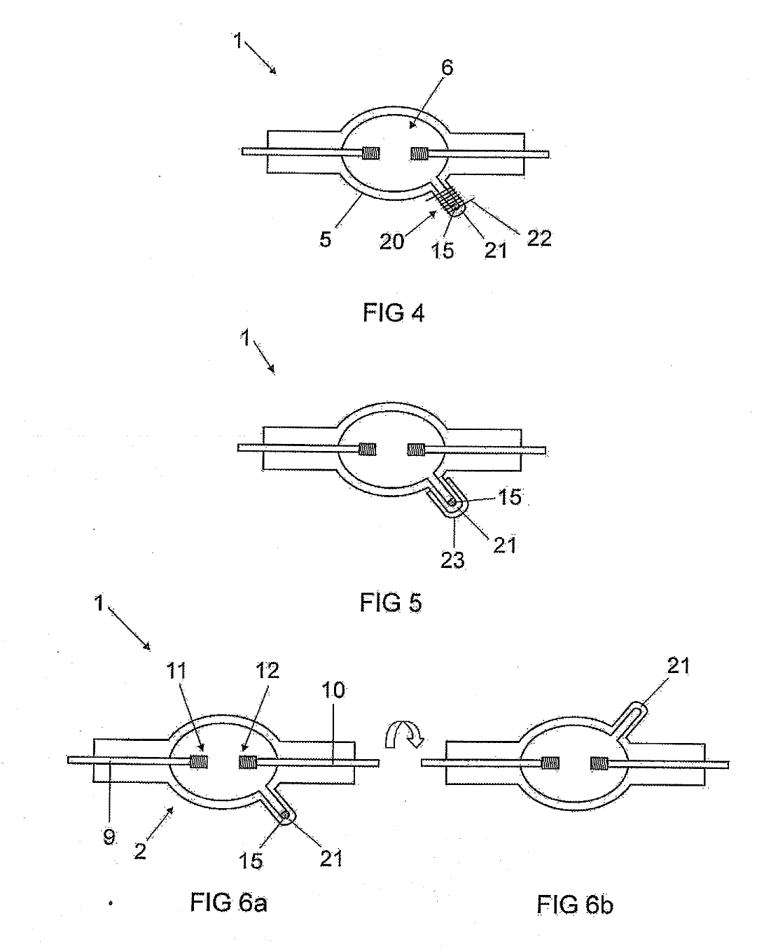

FIG. 4 shows a further exemplary embodiment in the case of which a cold trap 20 is implemented. The cold trap 20 is designed in this context as an extension 21 on the bellied central part 5. The extension 21 is of tubular design and extends in a laterally inclined fashion downward away from the central part 5. Here, as well, because of the lower temperature by comparison with the remaining region in the discharge space 6 it is possible for the storage material to condense out and then be deposited in the extension 21 as storage material 15. Provided for the purpose of releasing the electrode material stored in the storage material 15 is an active heating device 22 that can, for example, be fitted on the outside of the extension 21. The heater 22 can be activated and deactivated under electronic control. With the aid of this heating device 22, the temperature of the cold trap 20 can be controlled and the condensate can thereby be transformed into its gas phase.

A further exemplary embodiment is shown in a schematic illustration in accordance with FIG. 5. The extension 21 which constitutes a cold trap is illustrated in turn in the case of this design. Also provided is a heat accumulation device 23 that surrounds the extension 21 at least in part. In this context, the heat accumulation device 23 can be a jacket that can be put on and is coated on its inside and/or on its outside. The coating is designed, in particular, as a metallization such that the heat can be contained therein by thermal reflection and leads to heating of the storage material 15. It is also possible thereby to adjust the temperature of the cold trap 21 and thus cause the condensate to evaporate.

A further implementation is shown in FIGS. 6a, 6b. In the case of this approach, the extension 21 is positioned with a downward orientation in an initial position of the discharge vessel 2 which is shown by the left-hand image (FIG. 6a). Consequently, because of the temperature conditions, it is possible for the storage material to be condensed out and deposited as solid state material in the extension 21. If the aim is then to evaporate the storage material 15 again, in order to enable the electrode material to be transported via the gas phase, and to release the electrode material for deposition on the tips 11 and 12 of the electrodes 9 and 10 by dissociation, the discharge vessel 2 is rotated upward, in particular by 180°, such that the extension 21 is arranged with an upward orientation, the result being that heating occurs because of the thermodynamic conditions at this final position shown in the right-hand image in accordance with FIG. 6b. It is also possible for the storage material 15 to be evaporated as a consequence.

Individual features or several features of an exemplary embodiment can be combined with other exemplary embodiments.

1. A method for designing a length of an electrode of a discharge lamp, the method comprising:
introducing fill materials into a discharge space of a lamp bulb of the discharge lamp;
combining at least a first fill material with evaporated electrode material during operation of the discharge lamp; and
forming a storage material for the electrode material in the lamp bulb by the combination, the electrode material contained in the storage material being released again as a function of a temperature effect on the storage material and being transported to the tip of the electrode and being deposited there so as to lengthen the electrode.

2. The method as claimed in claim 1,
wherein the variation in length of the electrode is carried out under automatic control during operation of the discharge lamp.

3. The method as claimed in claim 1,
wherein the release of the electrode material contained in the storage material formed is carried out under control as a function of requirements during operation of the discharge lamp.

4. The method as claimed in claim 1,
wherein at least an inert gas and at least one of a metal halide and mercury is introduced as fill materials, and an additional halogen or a halide is introduced as first fill material.

5. The method as claimed in claim 4,
wherein the additional halogen is bromine, or the halide contains bromine.

6. The method as claimed in claim 4,
wherein the storage material has a dissociation temperature that is tuned to the temperature of the electrode during operation of the discharge lamp.

7. The method as claimed in claim 1,
wherein the first fill material is introduced in an amount that is larger by at least 100% than during operation without additional automatic variation in length of the electrode.

8. The method as claimed in claim 1,
wherein cooling of the lamp bulb is carried out locally in order to produce the storage material under control.

9. The method as claimed in claim 8,
wherein the cooling is adjusted automatically in dependence on at least one of the production, as a function of requirements, of storage material and on the extension of an electrode as a function of requirements.

10. The method as claimed in claim 8,
wherein storage material is condensed out during the local cooling of the lamp bulb and is deposited locally in the lamp bulb as solid state material.

11. The method as claimed in claim 10,
wherein the cooling is carried out locally such that the deposition of the storage material condensed out is prescribed locally in the lamp bulb.

12. The method as claimed in claim 10,
wherein the deposition of the storage material condensed out takes place in a shadow region of the electrode.

13. The method as claimed in claim 8,
wherein cooling is carried out by at least one of an air flow and a liquid flow incident on the lamp bulb from outside.

14. The method as claimed in claim 8,
wherein the lamp bulb is heated locally to above the dissociation temperature of the storage material in order to release the electrode material from the storage material.

15. The method as claimed in claim 8,
wherein the storage material is condensed out in an extension that is arranged on the bellied central part of the lamp bulb and designed as a cold trap.

16. The method as claimed in claim 15,
wherein the extension is heated from outside in order to release the electrode material from the storage material.

17. The method as claimed in claim 15,
wherein in order to heat the extension and the storage material deposited therein the lamp bulb is rotated such that the extension is moved from its downward pointing initial position into an upward-pointing final position.

18. A discharge lamp, comprising:
a lamp bulb that has a discharge space into which at least one elongated electrode extends and into which fill materials are introduced,
wherein the fill materials have at least a first fill material that can be chemically combined with evaporated electrode material during operation of the discharge lamp, and
wherein a storage material for the electrode material can be produced in the lamp bulb by the combination, it being possible for the electrode material contained in the storage material to be released again as a function of a temperature effect on the storage material, and for the released electrode material to be transported to the tip of the electrode so as to lengthen and be deposited on the electrode.

19. The discharge lamp as claimed in claim 18,
wherein a cold trap for condensing out storage material from the gaseous material in the discharge space.

20. The discharge lamp as claimed in claim 19,
wherein the cold trap has a cooling fan that produces an air flow incident locally on the lamp bulb from outside.

21. The discharge lamp as claimed in claim 19,
wherein the cold trap has a device that cools the lamp bulb with liquid medium from outside.

22. The discharge lamp as claimed in claim 19,
wherein the cold trap has an extension that is arranged on the central part and into which the storage material can be condensed out because of the lower temperature by comparison with the neighboring discharge space.

23. The discharge lamp as claimed in claim 18,
wherein the storage material condensed out can be heated specifically in order to release the electrode material contained therein as a function of requirements.

24. The discharge lamp as claimed in claim 18,
wherein the first fill material is a halogen or a halide.

25. The discharge lamp as claimed in claim 18,
wherein the amount of first fill material is larger than the amount of first fill material that is introduced during operation without an additional automatic variation in length of the electrode.

26. The discharge lamp as claimed in claim 18,
wherein the storage material has a dissociation temperature that is near to or lower than the temperature of an electrode tip during operation of the discharge lamp.

27. The discharge lamp as claimed in claim 18,
wherein it is designed as a reflector lamp.
